(19) United States
(12) Patent Application Publication
(10) Pub. No.: US 2024/0214203 A1
(43) Pub. Date: Jun. 27, 2024

(54) METHOD AND SYSTEM FOR USING NFT IN AN AUTOMATED COOKING RESTAURANT

(71) Applicant: KITCHEN ROBOTICS LTD, Modiin (IL)

(72) Inventors: Yair Gordin, Modiin (IL); David Ben-David, Rehovot (IL)

(73) Assignee: KITCHEN ROBOTICS LTD, Modiin (IL)

(21) Appl. No.: 18/086,071

(22) Filed: Dec. 21, 2022

(51) Int. Cl. H04L 9/32; G06Q 50/12

(52) U.S. Cl. CPC H04L 9/3213; G06Q 50/12; H04L 2209/60

(57) ABSTRACT

A novel system for providing a meal to a client having a mobile device, the system comprising a storage entity of a recipe provider (RP), a food provider (FP) site comprising at least one automated cooking restaurant (ACR), and wherein a meal that is ordered by a client, via the client's mobile device, is based on a recipe that is stored in the storage entity of the RP and the meal is cooked by an ACR from the at least one automated cooking restaurant.

### CROSS-REFERENCE TO RELATED APPLICATIONS

This is a utility patent application being filed in the United States as a non-provisional application for patent under Title 35 U.S.C. § 100 et seq. and 37 C.F.R. § 1.53(b) and further, this application is related to the following concurrently filed United States non-provisional applications for patents, both of which are incorporated herein in their entireties: (1) the application bearing the title of METHOD AND SYSTEM FOR PROVIDING A MEAL BY AN AUTOMATED COOKING RESTAURANT TO A CLIENT HAVING A MOBILE DEVICE, identified by attorney docket number 11053.1040 and client docket number Kir-203-CON1 and (2) the application bearing the title of METHOD AND SYSTEM FOR CONVERTING A RECIPE INTO AN NFT, identified by attorney docket number 11053.1050 and client docket number Kir-203-CON2.

### FIELD OF THE DISCLOSURE

The present disclosure relates to the field of automated-cooking-restaurant and more particularly the disclosure relates to a novel technique for handling a unique recipe by an automated-cooking-restaurant (ACR).

### BACKGROUND

A common automated cooking restaurant (ACR) is configured to work with a library of recipes. Recipes that were prepared by a chef that is associated with the manufacture of that ACR.

From time to time a customer of an ACR wishes to diversify his meal and to order a dish that is made based on a unique recipe. The unique recipe can be a recipe of a dish of a famous chef that was presented in a cook show, for example. Current ACRs are not configured to satisfy such a need.

The needs and the deficiencies that are described above are not intended to limit the scope of the inventive concepts of the present disclosure in any manner. The needs are presented for illustration only.

### BRIEF SUMMARY

The disclosure is directed to a novel technique for purchasing a meal from a food provider having an ACR wherein the recipe of the meal belongs to a 3^{rd} party. The 3^{rd} party can be a famous chef who offers recipes of the chef's well-known courses. Other example embodiments of the disclosed technique may use recipes of well known restaurants, etc. An example of an ACR can be “Beastro” manufactured by Kitchen Robotics Ltd Israel.

Thus, the disclosed technique associates two providers in order to deliver a course: a recipe provider and a food provider. The first provider is configured to deliver recipes that can be used again and again in a plurality of cases. The second provider, the food provider, is configured to deliver a single meal per each obtained recipe to be used only once. In the disclosure and claims, the words “meal”, “dish”, “plate” and “course” may be used interchangeably.

An example of such a recipe can be associated with a non-fungible token (NFT). An NFT is a record on a blockchain which is associated with a particular digital or physical asset. NFT is well known to a person having ordinary skill in the art and will not be further disclosed. In this disclosure the physical asset that is associated with an NFT is a meal, which is made by an ACR based on an associated recipe.

A customer who wishes to buy a meal from a food provider may receive a menu, which describes a plurality of courses. Some of the courses are based on recipes that belong to a 3^{rd} party. The 3^{rd} party can be a well-known chef or well-known restaurant. The name of those courses may be associated with the name of the well-known chef, “the pasta of chef . . . ”, for example. Such a recipe has to be purchased from that well-known chef or well-known restaurant. In response for obtaining the payment for that meal, the food provider may apply to the relevant recipe-provider-storage-device in order to purchase the recipe of that meal. The recipe-provider-storage-device can be a recipe-provider-website (RPW) or a recipe provider DB (RPDB) that is located in the food provider premises.

Other example of food providers may have one or more databases, wherein each database (DB) can be associated with a certain chef or a certain restaurant. Each database may comprise a plurality of recipes that were purchased from that chef or that restaurant. Each recipe can be embedded in an NFT. Each NFT can be associated with a unique transaction label having a unique-transaction-hash (UTH), for example. The UTH may comprise information regarding the RPW, information regarding the food provider, information regarding the course, etc. In addition the label may comprise a link to the RPW. The link can be embedded in a Q-bar or a barcode.

A client that purchased a course based on a recipe of a certain RPW may use the label in order to communicate with the relevant RPW to get a confirmation that this course was made according to recipe of that famous chef or famous restaurant. A client that has the appropriate application may scan the Q-bar or the barcode and accordingly may communicate with the RPW to get the confirmation.

In some example embodiment of the disclosed technique, in which asymmetric cryptography is used, the RPW may respond in two stages. During the first stage a private key can be sent toward the client's mobile device. During the second stage the relevant recipe can be sent embedded within an encrypted NFT toward the food provider. The NFT can be encrypted by using a public key of that RPW. Other example embodiments of the disclosed technique may use other encryption methods.

An example of an NFT may comprise a list of food ingredients, the weight of each ingredient, when to add it to a pot. After collecting the ingredients, the NFT may comprise instructions how to cook this course, in which temperature, how long, whether to mix it during cooking or not, etc. In addition the recipe may comprise platting instructions. In some embodiments this data can be encrypted.

During purchasing of a meal, an example embodiment of the disclosed technique can be configured to prompt the client to modify the recipe according to the client's needs. In such embodiment the food provider can be configured to ask the customer questions about the customer's preferences, customer's health conditions, etc. The questions may check whether the customer is sensitive to a certain ingredient, how to cook the course, whether the customer prefers the steak well done or rare, whether to add salt or other spices, etc. Thus, the cooked course is made according to the preferences of the customer.

Some example embodiments of the disclosed technique allow the customer to select ingredients. The customer can select between beef, chicken, vegetables, etc. Consequently, although the course is delivered by an ACR, by purchasing the NFT the customer has the option to define a customized meal.

An example embodiment of the disclosed technique may comprise one or more Recipe-Provider-Website (RPW). Each RPW can be configured to generate a plurality of NFTs. An example of RPW can be associated with a certain chef and may comprise NFT of recipes of that chef. Another example of RPW can be associated with a famous restaurant. Such a RPW may store a plurality of NFTs of recipes that can be used in an ACR.

A customer who wishes to buy a meal may receive a menu with a plurality of courses. Some of the courses are based on recipes that belong to the food provider. Other courses can be based on recipe that belongs to a 3^{rd} party, a RPW. Each RPW can be associated with a certain chef or a certain restaurant. Upon selecting a certain course, a request for it's recipe can be sent to the relevant RPW. In some embodiments the recipe may be stored in a database related to that chef or that restaurant. Wherein that database is located at the food provider premises.

After obtaining the recipe, from the RPW or from the database that is related to that chef, a questionnaire can be presented to the customer prompting the customer to define his preferences regarding tastes and way of cooking. Whether the customer prefers a spicy meal, the level of salt, paper, sugar, etc. The way of cooking can define the type of oil to be used, the level of cooking (well done or rare), whether to use an oven or a grill, etc. In addition the recipe may comprise plating information. Plating information may have instruction to be done manually by a cook that is associated with the ACR. The plating information may instruct the cook to mix the course before serving it, or to add a potato beside the stack, for example.

In some example embodiments of the disclosed technique the NFT may comprise delivering information. If the order is for a customer in a restaurant the delivering information may indicate a table and the location of the customer in that table. If the course is a take-away-course, then the cook is prompt to put the course in appropriate box and to put the box in a bag with a label that addresses the shipment to that customer, etc.

Upon loading the recipe information to an ACR, the ACR is configured to process the information and to convert it into three sets of instructions, per each meal that is embedded in the NFT, for example. The first set of instructions can be loaded to an associated dispenser informing the dispenser which food ingredients to deliver to a pot for cooking the relevant course.

The second set of instructions is delivered to the cooking apparatus instructing it how to cook this pot. The instructions may comprise the temperature, the period of cooking, mixing instruction during cooking, etc. The 3^{rd} set may comprise platting instructions to be delivered to the cook that is associated with the ACR. These instructions can be presented on a display that is associated with the cook.

The platting instructions may comprise printing a label that can be associated with that meal. The label may comprise delivering information and information about the course. In addition the label may include a barcode or Q-bar that comprises a link to the RPW that is associated with this meal. The client of this meal may use his mobile device in order to read the barcode or Q-bar and accordingly may communicated with the RPW in order to get confirmation that this course was made according to a recipe provided by the chef or the restaurant that is associated with this RPW. The confirmation is based on the received NFT. A few non-limiting examples of a mobile-device can be: a laptop, a mobile phone, a PDA (personal digital assistance), a smart phone, a tablet computer, etc.

These and other aspects of the disclosure will be apparent in view of the attached figures and detailed description. The foregoing summary is not intended to summarize each potential embodiment or every aspect of the present invention, and other features and advantages of the present invention will become apparent upon reading the following detailed description of the embodiments with the accompanying drawings and appended claims.

Further, although specific embodiments are described in detail to illustrate the inventive concepts to a person skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the embodiments with the accompanying drawings and appended claims.

### BRIEF DESCRIPTION OF THE DRAWINGS

Some examples of embodiments of the present disclosure will be understood and appreciated more fully from the following detailed description, taken in conjunction with the drawings in which:

FIG. 1 schematically illustrates a block diagram with relevant elements of an example of a system for using NFT by a food provider;

FIG. 2 illustrates a flowchart of a method with relevant processes of a task for handling a new recipe, received from a recipe-provider, and converting it into an NFT that is associated with a label;

FIG. 3 illustrates a flowchart of a method with relevant processes that can be implemented by a food provider;

FIG. 4 illustrates a flowchart of a method with relevant processes of a second example of a method for converting a new recipe into an NFT; and

FIG. 5 illustrates a flowchart of a method with relevant processes that can be implemented by a food provider wherein the NFT is encrypted.

### DETAILED DESCRIPTION OF SOME EXAMPLE EMBODIMENTS

Turning now to the figures in which like numerals represent like elements throughout the several views, in which exemplary embodiments of the disclosed techniques are described. For convenience, only some elements of the same group may be labeled with numerals.

The purpose of the drawings is to describe examples of embodiments and not for production purpose. Therefore, features shown in the figures are chosen for convenience and clarity of presentation only. In addition the figures are drawn out of scale. Moreover, the language used in this disclosure has been principally selected for readability and instructional purposes, and may not have been selected to define or limit the inventive subject matter, resort to the claims being necessary to determine such inventive subject matter.

In this specification, these implementations, or any other form that the invention may take, may be referred to as techniques. In general, the order of the steps of disclosed processes may be altered within the scope of the invention. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

In the following description and claims, the words “unit,” “element,” “module”, and “logical module” may be used interchangeably. Anything designated as a unit or module may be a stand-alone unit or a specialized or integrated module. A unit or a module may be modular or have modular aspects allowing it to be easily removed and replaced with another similar unit or module. In addition the terms element and section can be used interchangeably. In the following description and claims, the words “course,” “dish”, and “meal” may be used interchangeably

Each unit or module may be any one of, or any combination of, software, hardware, and/or firmware, ultimately resulting in one or more processors programmed to execute the functionality ascribed to the unit or module. Additionally, multiple modules of the same or different types may be implemented by a single processor. As used herein, the term ‘processor’ can refer to a computer such as but not limited to Intel NUC, wherein NUC stands for Next-Unit-of-Computing or “Amazon EC2 A1 Instances” or “Amazon EC2 P3 Instances”, which are maintained by Amazon Crop USA, for example.

Software of a logical module may be embodied on a computer readable device such as a read/write hard disc, CDROM, Flash memory, ROM, or other non-transitory computer readable storage device, etc. In order to execute a certain task a software program may be loaded to an appropriate processor as needed. In the present disclosure the terms task, method, process can be used interchangeably. In the present disclosure the verbs transmit, transfer or be placed in a queue can be used interchangeably.

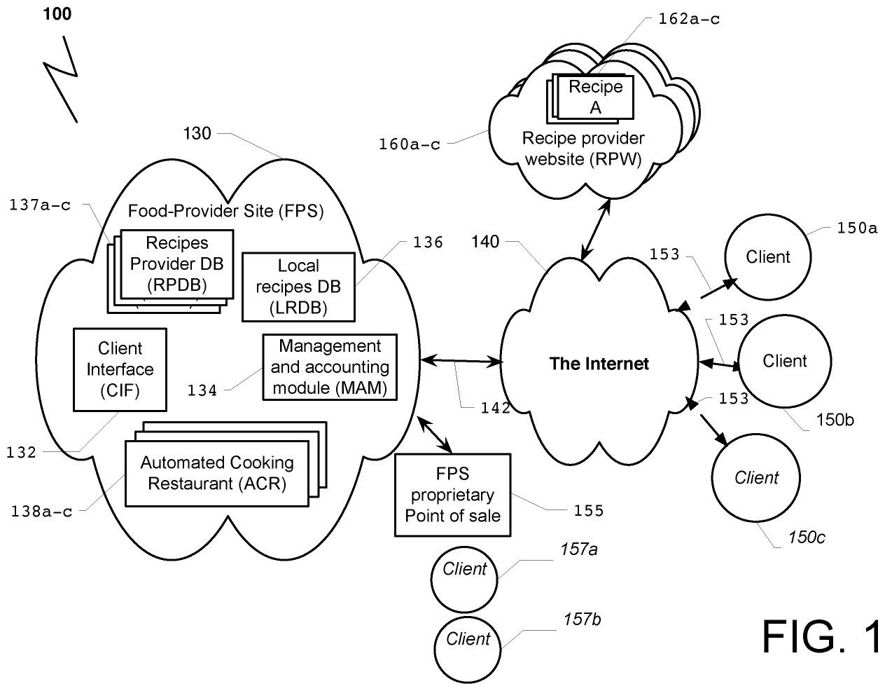

FIG. 1 schematically illustrates a block diagram with relevant elements of an example of a system 100 in which an NFT can be used for ordering a course to be made by an ACR 138a-c. System 100 may comprise a Food-Provider-Site (FPS) 130, one or more Recipe-provider-websites (RPW) 160a-c, a network 140, and a plurality of clients 132a-c. The communication between FPS 130, RPWs 160a-c, network 140, and the clients 132a-c can be based on Internet Protocol (IP). Communication over an IP network is well known to a person having an ordinary skill in the art and will not be further disclosed.

An example of FPS 130 may comprise a client interface module (CIF) 132, management and accounting module (MAM) 134, local recipe DB (LRDB) 136 and one or more ACRs 138a-c. FPS 130 may represent a site of a food provider. Some example embodiments of sites of FPS 130 may comprise one or more DBs 137a-c that comprises recipes, which belong to a recipe provider. In the disclosure and claims, the terms “food provider premises”, “food provider site”, and “Food-Provider-Cloud” may be used interchangeably. The recipe provider can be a famous chef or a well-known restaurant. Along the present disclosure and the claims such a DB can be referred as recipe provider DB (RPDB) 137a-c. Such a RPDB 137a-c may replace one or more RPW 160a-c. Each one of the RPDB 137a-c and RPW 160a-c may store a plurality of original-recipe of the relevant recipe provider. In addition. Each one of the RPDB 137a-c and RPW 160a-c can be associated with a server that can communicates with the different entities of system 100.

An example of CIF 132 can be configured to communicate with a client 150 via the client's mobile device via communication links 153. The communication links 153 can be based on protocol such as but not limited to cellular protocol, Wi-Fi protocol or a Bluetooth protocol, etc. Communication via cellular, Wi-Fi network or Bluetooth protocols is well known to a person having an ordinary skill in the art and will not be further disclosed. In some embodiments of the disclosed technique CIF 132 may communicate with a client 150a-c via a proprietary point of sale 155 of FPS 130. Proprietary point of sale 155 can be used by clients 157a-c that visit a restaurant of the food-provider.

A client 150a-c that applies to FPS 130 via CIF 132 may obtain a menu. The menu may offer a plurality of courses. Some of the courses are based on recipes that belong to the food provider and are stored in LRDB 136. Other courses can be based on recipes that belong to a recipe-provider. The recipe-provider can be a certain chef or a certain restaurant. Those recipes can be stored in an appropriate RPDB 137a-c or in one of RPW 160a-c.

After selecting a certain course, the CIF 132 may ask the client to give personal information such as telephone number, address, payment information etc. Then CIF 132 may present a questionnaire to the client 150a-c prompting the client 150a-c to define his preferences regarding selected ingredients, tastes and way of cooking. Whether the customer prefers a spicy meal, the level of salt, paper, sugar, etc. The way of cooking can define the type of oil to be used, the level of cooking (well done, medium or rare), whether to use an oven or a grill, etc. Thus, the client has the possibility to convert the recipe into an adapted-recipe, which is adapted to the client's preferences. In addition the questionnaire may ask for plating information. Plating information may have instruction to be done manually by a cook that is associated with the ACR 138a-c. The plating information may instruct the cook to mix the course before serving it, or to add a potato beside the stack, etc.

The plating information may comprise delivery information. For a client in a restaurant, the delivery information may include the table and the location of the customer in that table. If the course is a take-away-course, then the cook is prompt to put the course in appropriate box and to put the box in a bag with a label that addresses the shipment to that customer, etc.

After collecting the information from the client, CIF 132 may transfer the information to MAM 134. MAM 134 may process the adapted-recipe and determine the price of the meal and the source of the recipe, is it LRDB 136, RPDB 137a-c, or RPW 160a-c. If the source is LRDB 136, then the price is communicated to CIF 136 in order to collect the payment from the appropriate client 150a-c and the recipe is delivered to the relevant ACR 138a-c. If the source of the recipe is RPDB 137a-c or RPW 160a-c, then a request for it's recipe can be sent to the relevant RPW 160a-c or RPDB 137a-c, for example. RPW 160a-c or RPDB 137a-c may respond by sending the recipe in association with an NFT.

In some example embodiments the NFT may include instructions to print a label with information about the meal and a barcode or Q-Bar. In addition the barcode or Q-Bar may comprise a link to the RPW 160a-c or an address in the RPDB 137a-c. A client 132a-c who purchased the course may use the label in order to communicate with the relevant RPW 160a-c or RPDB 137a-c to get a confirmation that this course was made according to recipe of that famous chef or famous restaurant. A client that has the appropriate application may scan the Q-bar or the barcode and accordingly may communicate with the RPW 160a-c or RPDB 137a-c to get the confirmation. Applications for processing barcodes or Q-bar are well known to a person having ordinary skill in the art and will not be further disclosed.

Other example embodiments of the disclosed technique may use an encrypted NFT that comprise the adapted-recipe. The NFT can be encrypted by using a public key of that RPW 160a-c or RPDB 137a-c and a private key, for example. The private key can be sent to the client 150a-c mobile device. In such example embodiment the MAM 134 can be configured to obtain the encrypted adapted-recipe from RPW 160a-c or RPDB 137a-c and to obtain the private key from the mobile device of the relevant client 150a-c and to decrypt the adapted-recipe.

The decrypted adapted recipe can be divided by MAM 134 into three sets of instructions. The first set can be loaded to an ACR 138a-c that is located near the client and it includes commands for preparing the dish according to the decrypted adapted-recipe. The second set of instruction can be loaded to a display of a workstation of a cook (not shown in the figures). This set may include plating information, delivery information, price of the dish and a barcode or a Q-bar. The information can be printed on a label that is associated with the dish.

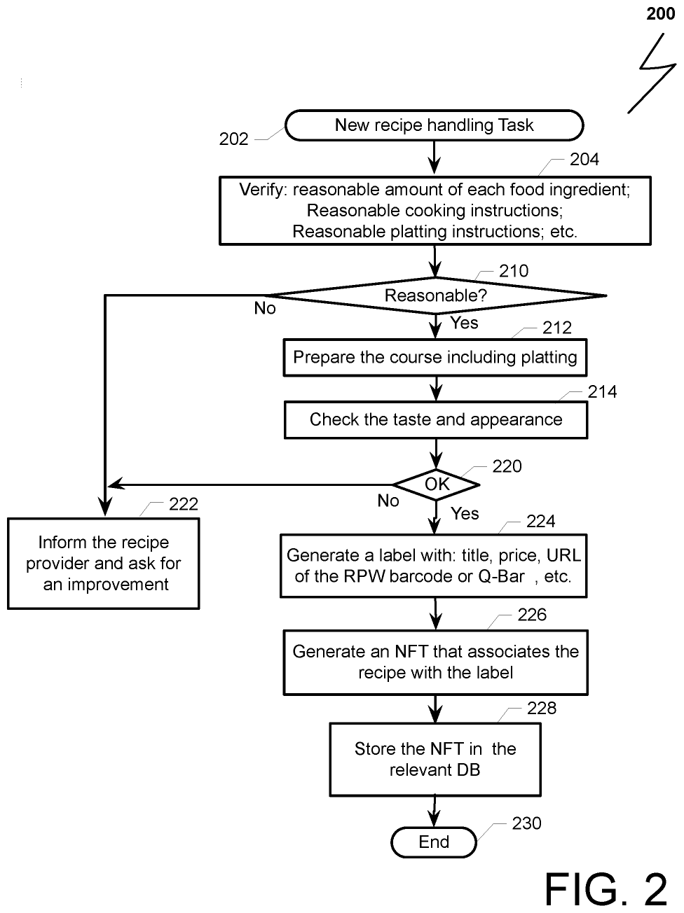

The 3^{rd} set may comprise business instructions such as but not limited to the price of the dish. In addition the cost of the dish may be calculated too. Further, logistic instruction can be generated based on the food ingredients that were used for preparing the dish. The amount of each food ingredients that was involved in preparing the dish is reduced from the amount in the stock. Those instructions can be delivered to the appropriate destination. MAM 134 may send the logistic information to a store house (not shown in the figures) or to a logistic work station of the food provider (not shown in the figures). Business information may be sent by MAM 134 to the relevant recipe provider, for example. More information on the operation of an example of system 100 is disclosed below in conjunction with FIG. 2 to FIG. 5.

FIG. 2 illustrates a method 200 with relevant processes of a task 200 for handling a new recipe, received from a recipe-provider, and converting it into an NFT that is associated with a label. At block 202 a new recipe is obtained from a recipe-provider via RPW 160a-c or via RPDB 137a-c. Next, 204 MAM 134 (FIG. 1) may check 204 whether the new recipe is reasonable, whether the list of the ingredients is reasonable. Whether the amount of each food ingredient is reasonable. Are the cooking instructions and the platting instructions are reasonable.

At block 210 a decision is made whether the result of the checking 204 is reasonable. If 210 no, then process 200 proceed to block 222 and inform the recipe-provider the result of the checking and ask 222 it to deliver an improved recipe. If 210 the result of the checking 204 is reasonable, then the recipe is loaded to an ACR 138a-c with a command to prepare 212 the course. In parallel platting instructions 212 can be given to a cook via the cook's work station (not shown in the figures). At block 214 a chef of the food provider may taste the prepared dish and its appearance. If 220 both of them are good or better than good. If 220 not, then then process 200 proceed to block 222 and inform the recipe-provider the result of the checking 214 and ask 222 it to deliver an improved recipe.

If 220 both of them, the appearance and the taste, are acceptable. Then, a label can be generated 224. The label may comprise the title of the dish, the price, the name of the relevant client 150a-c or 157a-c, delivering information and information about the course.

In addition the label may include a barcode or Q-bar that comprises a link to the RPW 160a-c that is associated with this recipe. Next 226 an NFT can be generated by MAM 134 (FIG. 1). The NFT may associate 226 the recipe and the label. Then, the NFT can be stored 228 in the appropriate DB depending on the source of the recipe. If the source is a chef of the food provider, then the DB will be LRDB 136. If the recipe is generated by a famous chef or a famous restaurant, then the NFT may be stored in RPDB 137a-c or RPW 160a-c and process 200 can be terminated 230.

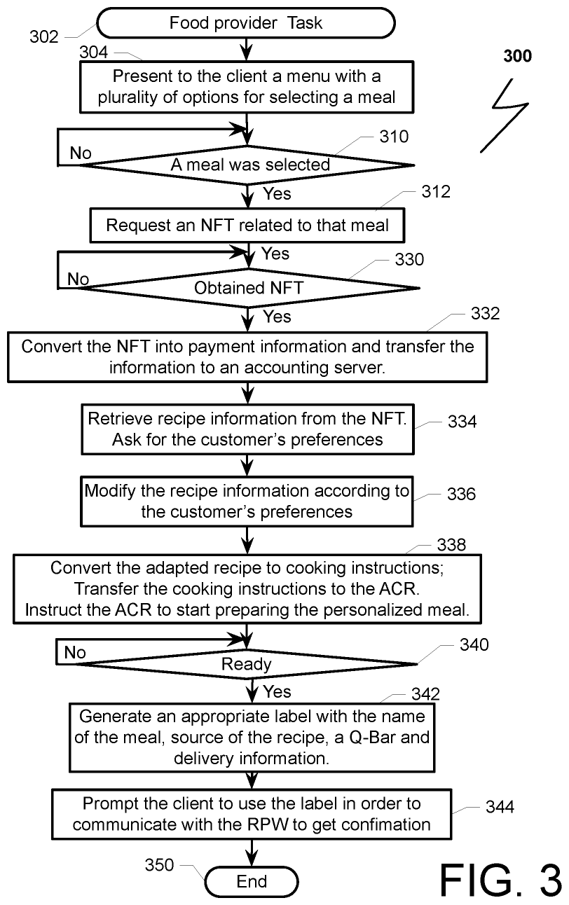

FIG. 3 illustrates a method 300 with relevant processes that can be implemented by a food provider in order to deliver a course to a client. Process 300 can be initiated 302 by CIF 132 when a client 150a-c or 157a-b (FIG. 1) tries to order a meal. After initiation a menu can be presented 304 to the client prompting the client to select a meal. The menu comprises a lot of options of meals. Some of the meals are based on recipes that belong to a recipe provider and may be stored in RPDB 137a-c or RPW 160a-c (FIG. 1). Then, process 300 may wait 310 until the client selects a course.

After selecting the meal a request for an NFT that is related to that course can be delivered to the appropriate RPW 160a-c and process 300 may wait 330 to obtain the NFT. Upon receiving the NFT. The NFT can be processed 332 by MAM 134 (FIG. 1). Payment information can be transferred to the client via CIF 132 and a copy can be stored in an accounting server.

Next information related to the recipe can be retrieved 334 from the NFT and a questionnaire can be presented 334 to the client 150a-c prompting the client 150a-c to define his preferences regarding selected ingredients, tastes and way of cooking and platting. Whether the customer prefers a spicy meal, the level of salt, paper, sugar, etc. The way of cooking can define the type of oil to be used, the level of cooking (well done, medium or rare), whether to use an oven or a grill, etc. Thus, the client has the possibility to convert the recipe into an adapted-recipe, which is adapted 334 to the client's preferences.

At block 336 the recipe information is modified according to the client's preferences and an adapted-recipe is generated. Next the adapted-recipe is processed 338 to generate cooking instructions and plating instructions. The cooking instructions are delivered to an appropriate ACR 138a-c (FIG. 1) instructing it to start preparing the personalized meal based on the adapted-recipe. The plating instructions can be presented to a cook that stands near the ACR. Then, process 300 may wait 340 until the meal is ready.

Next a label can be printed 342 with the name of the meal, the source of the recipe, delivery information and a Q-Bar or a barcode. The delivery information can be the table, for a client of a restaurant, or an address for a take away client. Finally the client is prompted 344 to communicate with the relevant RPW in order to verify that the meal is based on a recipe of the recipe provider and process 300 is terminated.

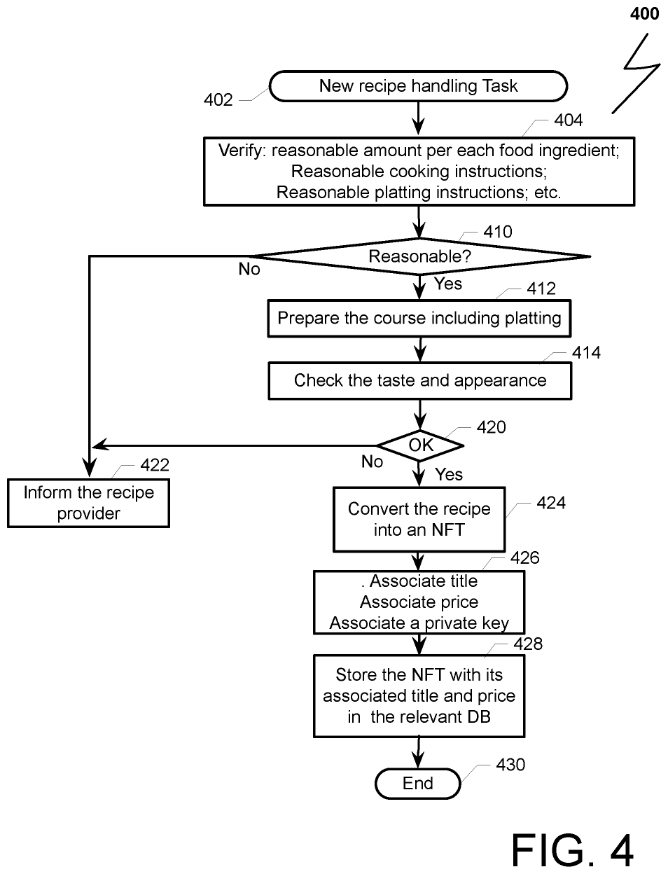

FIG. 4 illustrates a method 400 with relevant processes of another example of a method for converting a new recipe into an NFT that is associated with encryption. At block 402 a new recipe is obtained from a recipe-provider via RPW 160a-c or via RPDB 137a-c. Next, MAM 134 (FIG. 1) may check 404 whether the new recipe is reasonable, whether the list of the ingredients is reasonable. Whether the amount of each food ingredient is reasonable. Are the cooking instructions and the platting instructions are reasonable, etc.

At block 410 a decision is made whether the result of the checking process 404 is reasonable. If 410 no, then process 400 proceed to block 422 and inform the recipe-provider the result of the checking and ask 422 it to deliver an improved recipe. If 410 the result of the checking 404 is reasonable, then the recipe is loaded to an ACR 138a-c with a command to prepare 412 the course. In parallel platting instructions 412 can be given to a cook via the cook's work station (not shown in the figures). At block 414 a chef of the food provider may taste the prepared dish and its appearance. If 420 both of them are good or better than good. If 420 not, then then process 400 proceed to block 422 and inform the recipe-provider the result of the checking 414 and asks 422 to deliver an improved recipe.

If 420 both of the features, the appearance and the taste, are acceptable. Then, the recipe can be converted 424 into an NFT. The NFT can be encrypted by the RPW 160a-c (FIG. 1). In some example embodiments of the disclosed technique the encryption may use a public key and a private key. The NFT can be encrypted by using the public key of that RPW 160a-c and be sent to the food provider to be stored in RPDB 137a-c while the private key can be delivered to the mobile device of the client 150a-c that purchases the NFT. In parallel the title of the course and its price can be added to the NFT 426 and be sent to MAM 134 (FIG. 1) that stores 426 the NFT in RPDB 137a-c. In some embodiments the address in RPDB 137a-c can be indicated in the NFT that was delivered to the client 150a-c and process 400 can be terminated 430.

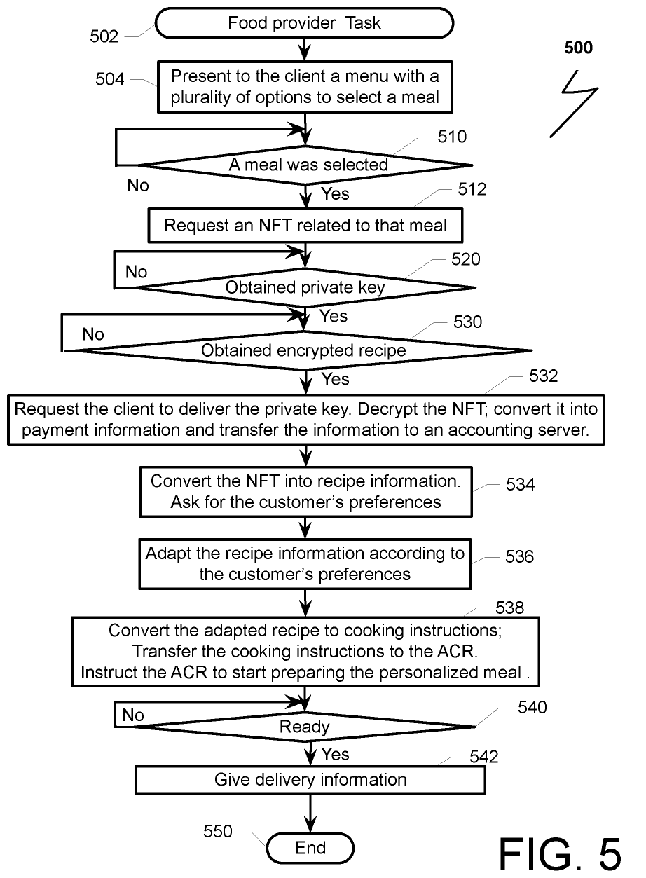

FIG. 5 illustrates a flowchart of a method 500 with relevant processes that can be implemented by a food provider wherein the NFT is encrypted. Method 500 can be initiated 502 by CIF 132 (FIG. 1) when a client 150a-c or 157a-b (FIG. 1) starts ordering a meal. After initiation 502 a menu can be presented 504 to the client prompting the client to select a meal. The menu may comprises a plurality of options of meals. Some of the meals are based on recipes that belong to a recipe provider and may be stored in RPDB 137a-c or RPW 160a-c (FIG. 1). Then, process 300 may wait 510 until the client selects a meal.

After 510 selecting the meal a request for an NFT that is related to that meal can be delivered 512 to the appropriate RPW 160a-c and process 500 may wait 520 to obtain a private key that is related to that NFT. The private key can be obtained by a mobile device of the client and be stored in the mobile device. Then method 500 may wait 530 to obtain the encrypted recipe that is associated with that NFT.

At block 532 process 500 may ask the mobile device of the client to deliver the received private key in order to decrypt the NFT. The decrypted NFT can be processed 532 by MAM 134 (FIG. 1). Payment information can be transferred to the client via CIF 132 and a copy can be stored in an accounting server. Recipe information can be presented to the client and process 500 may ask 534 the preferences of the client in order to generate an adapted-recipe 536.

Next the adapted-recipe is processed 538 in order to generate cooking instructions and plating instructions. The cooking instructions can be delivered to an appropriate ACR 138a-c (FIG. 1) instructing it to start preparing the personalized meal based on the adapted-recipe. The plating instructions can be presented to a cook that stands near the ACR. Then, process 500 may wait 540 until the meal is ready.

When 540 the meal is ready, then a label with delivery information can be printed and be associated with the ready meal. The delivery information can be a table, for a client of a restaurant, or an address for a take away client and process 500 can be terminated.

In the description and claims of the present disclosure, each of the verbs, “comprise”, “include”, “have”, and conjugates thereof, are used to indicate that the object or objects of the verb are not necessarily a complete listing of members, components, elements, or parts of the subject or subjects of the verb.

The present disclosure has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons skilled in the art that the present invention is not limited by what has been particularly shown and described herein above. Rather the scope of the invention is defined by the claims that follow.

What is claimed is:

1. A system for providing a meal to a client having a mobile device, the system comprising:
i. a storage entity of a recipe provider (RP);
ii. a food provider (FP) site comprising at least one automated cooking restaurant (ACR); and
iii. wherein a meal that is ordered by a client, via the client's mobile device, is based on a recipe that is stored in the storage entity of the RP and the meal is cooked by an ACR from the at least one automated cooking restaurant of the food provider.

2. The system of claim 1, wherein the recipe provider is a well-known chef.

3. The system of claim 1, wherein storage entity of the recipe provider is a recipe-provider-website (RPW).

4. The system of claim 3, wherein in response to ordering the meal, the client device obtains a link a non-fungible token (NFT) that is stored in the RPW.

5. The system of claim 4, wherein the NFT is encrypted.

6. The system of claim 1, wherein the food provider (FP) site further comprising a client interface (CIF) that is configured to present a menu to the client and to obtain the client selected meal.

7. The system of claim 6, wherein the CIF is configured to obtain the client's preferences regarding the meal and generate an adapted recipe.

8. The system of claim 7, wherein the client's preferences comprising type of ingredients to be used.

9. The system of claim 7, wherein the client's preferences comprising level of cooking.

10. The system of claim 7, wherein the recipe is adapted according to the client's preferences.

11. The system of claim 4, wherein the NFT further comprising instructions to generate a label.

12. The system of claim 11, wherein the label comprises delivery information.

13. The system of claim 11, wherein the label comprises a second link to the RPW.

14. The system of claim 13, wherein the second link is embedded in a Q-Bar that is printed on the label.

15. The system of claim 13, wherein the client is prompted to use the second link in order to communicate with the RPW for getting confirmation that the meal is based on a recipe that belongs to that recipe provider.
